(19) United States
(12) Patent Application Publication
(10) Pub. No.: US 2016/0341419 A1
(43) Pub. Date: Nov. 24, 2016

(54) HEATING DEVICE FOR HEATING FLUIDS, AND METHOD FOR OPERATING A HEATING DEVICE OF THIS KIND

(71) Applicant: E.G.O. Elektro-Geraetebau GmbH, Oberderdingen (DE)

(72) Inventor: Henry Fluhrer, Bretten (DE)

(21) Appl. No.: 15/157,074

(22) Filed: May 17, 2016

(30) Foreign Application Priority Data
May 18, 2015 (EP) 15168028.7

(51) Int. Cl. F22B 1/28; H05B 3/03; H05B 1/02

(52) U.S. Cl. CPC F22B 1/28; H05B 1/0269; H05B 1/0202; H05B 3/03

(57) ABSTRACT

A heating device for heating fluids has a flat support with a surface on which heating elements are arranged distributed over the surface area and are divided into one or more heating circuits which can be operated separately from one another. A temperature sensor device is provided with a sensor layer which covers the surface area of the heating elements. At least two sensor electrodes in an electrode layer are fitted onto the sensor layer, the at least two sensor electrodes being electrically disconnected from one another and having finger-like or turn-like sensor electrode sections which run at a distance of less than 2 cm in relation to one another. The width of in each case two sensor electrode sections which are arranged next to one another is less than 2 cm in each case. A control apparatus for evaluating the temperature sensor device is provided.

### CROSS-REFERENCE TO RELATED APPLICATIONS

This application claims priority to European Application No. 15168028.7, filed on May 18, 2015, the contents of which are hereby incorporated herein in its entirety by reference.

### BACKGROUND

The invention relates to a heating device for heating fluids, in particular liquids, and also to a method for operating a heating device of this kind.

WO 02/12790 A1 discloses a cooking device with steam generation by means of a heating device which has a steam generation container in the form of an upright tube. A flat heating element is arranged on the outside of the steam generation container. Water is supplied to the steam generation container from below, while the generated steam can escape at the top and is used in the cooking device for steam cooking.

WO 2007/136268 A1 and DE 102013200277 A1 disclose performing temperature detection by means of a dielectric insulation layer in heating devices with heating elements which are distributed over the surface area. In this case, the so-called leakage current or fault current which flows through the insulation layer from the heating elements is measured at electrodes. This insulation layer has an electrical resistance which falls as the temperature rises. Therefore, local overheating can be established over a large surface area, without temperature sensors as discrete components being required for this purpose.

### BRIEF SUMMARY

The invention is based on the problem of providing a heating device of the kind mentioned in the introductory part and also a method for operating the heating device, with which heating device and method prior art problems can be solved and it is possible, in particular, to be able to reliably detect a temperature or an overtemperature at a heating circuit of the heating device or at the entire heating device.

This problem is solved by a heating device, and also by a method. Advantageous and preferred refinements of the invention are the subject matter of the further claims and will be explained in greater detail in the text which follows. In the process, some of the features will be described only for the heating device or only for the method. However, irrespective of this, they are intended to be able to apply both for the heating device and also for the method independently. The wording of the claims is incorporated in the content of the description by express reference.

Provision is made for the heating device for heating fluids, in particular for heating liquids, in order to thereby operate a steam cooker, to have the following features. The heating device has a flat support with a surface, wherein the support can be either substantially or entirely flat as a kind of plate. As an alternative, the support can be bent and, particularly advantageously, be a closed tube or a tubular container which contains the fluid which is to be heated. Heating elements are arranged distributed over the entire surface of the support, advantageously on an outer face which does not come into contact with the fluid which is to be heated. The heating elements advantageously cover a large portion, preferably at least 50% or even at least 70%, of the support or its surface. The heating elements are divided into one or more heating circuits which can be operated separately from one another. Each heating circuit has at least one heating element, wherein a heating element is therefore intended to be understood to mean a section of a heating circuit here. Each heating circuit particularly advantageously has a plurality of individual heating elements which are interconnected or can be interconnected in a parallel, serial or mixed manner.

Furthermore, a temperature sensor device with a sensor layer which is advantageously electrically insulating is provided. The sensor layer is fitted by way of a surface area which covers at least the surface area of the heating elements, particularly advantageously entirely covers the said heating elements. Provision can be made for the sensor layer to be formed over the entire surface area and to be closed. The said sensor layer is preferably fitted above the heating elements, and if it is fitted preferably directly onto the heating elements, it should be electrically insulating. This sensor layer has abovementioned temperature-dependent properties in respect of its electrical resistance, that is to say is a kind of sensor element. The sensor layer is particularly advantageously designed as described in the abovementioned WO 2007/136268 A1 and DE 102013200277 A1 with a severe drop in resistance at temperatures of 200° C. to 300° C., for example starting from approximately 250° C. These temperatures are considered to be critical for heating devices of this kind. If temperatures are exceeded, the heating device may otherwise be damaged or destroyed.

At least two sensor electrodes are fitted onto the sensor layer, advantageously in an electrode layer, specifically directly onto the sensor layer. These two sensor electrodes are electrically disconnected from one another and, unlike the sensor layer, are not formed simply over a large surface area, but rather have finger-like or turn-like and elongate sensor electrode sections. These sensor electrode sections run at a distance of at least 2 cm, advantageously less than 1 cm or even less than 0.5 cm, for example only 1 mm to 3 mm, in relation to one another. In sections, the sensor electrode sections should have an identical width and/or a constant width. The width of in each case two sensor electrode sections which are arranged next to one another, that is to say of in each case one of the two sensor electrodes, is advantageously less than 2 cm. The width is particularly advantageously less than 1 cm and more than 1 mm.

Finally, a control apparatus for evaluating the temperature sensor device is provided. This control apparatus can be provided only for the temperature sensor device. As an alternative, the control apparatus can be provided in a controller for the further heating device or the entire electrical appliance in which the heating device is installed. In this case, good interaction with the operation of the heating device is also possible on the basis of information or data from the temperature sensor device. However, a separate control apparatus only for the temperature sensor device or only for the heating device can also be provided.

By virtue of providing two sensor electrodes in the temperature sensor device, which two sensor electrodes together overlap the surface area of the heating device or at least of the heating circuits, it is possible to monitor the surface area for local overtemperatures or overheating phenomena, that is to say so-called hot spots, this not being possible with individual discrete temperature sensors. Local overtemperatures of this kind usually have an expansion range of at most 2 cm to 3 cm with very high critical temperatures, so that a very narrow network of discrete temperature sensors has to be fitted. Increased fail-safety or double fail-safety can be achieved by virtue of providing two sensor electrodes. Even if one of the two sensor electrodes fails or is damaged, monitoring for an overtemperature is still possible by means of the other sensor electrode, so that the heating device can continue to be operated. In addition to the increased reliability or fail-safety, considerably improved reliability for identifying an overtemperature of this kind can also be achieved. If, specifically, both sensor electrodes identify an increased fault current, there is also a very high probability of an overtemperature of this kind actually being present in a region.

In an advantageous refinement of the invention, provision can be made for sensor electrode sections of the two sensor electrodes, which sensor electrode sections are arranged next to one another, to run parallel to one another. The sensor electrodes sections advantageously also have an identical and/or constant width, that is to say one sensor electrode section should have an identical and constant width. Sensor electrode sections of the two sensor electrodes particularly advantageously alternate, that is to say are arranged alternately next to one another.

In a refinement of the invention, it is possible to divide the temperature sensor device into a plurality of, at least two and preferably three, identification regions. In this case, the division should be such that each identification region corresponds to a heating circuit or is associated with a heating circuit. This is advantageous in that an identification region is congruent with a heating circuit. Therefore, each region of each heating circuit is separately monitored and/or safeguarded in respect of overtemperature.

In one refinement of the invention, the sensor electrode sections may run in the manner of elongate tracks on the support, that is to say in a bifilar fashion as it were. In this case, the sensor electrode sections of the two sensor electrodes once again run parallel to one another and next to one another and/or alternately. In this case, the profile of the said sensor electrode sections particularly advantageously corresponds to a so-called meandering form in the case of a flat support. In the case of a support in tubular form, the sensor electrode sections with a bifilar profile can also correspond to fully surrounding turns with a spiral profile.

In an alternative refinement of the invention, the sensor electrode sections can be designed such that they engage one into the other in a comb-like manner or are interleaved one into the other in a comb-like manner, this being the case in regions which overlap with the heating circuits, as has been described above. The sensor electrode sections of the two sensor electrodes should be arranged in an alternating manner in this case too.

Owing to the arrangement of the sensor electrode sections alternately next to one another and close to one another, it is possible for a region with an overtemperature to, as it were, overlap sensor electrode sections of the two sensor electrodes on account of its local expansion. Therefore, the overtemperature can also be detected actually at the two sensor electrodes and therefore with twice the reliability.

In the case of the refinement in which the sensor electrode sections engage one in the other, the sensor electrode sections can advantageously be designed in the manner of fingers. The sensor electrode sections can project from continuous base sections of the sensor electrodes, which base sections run substantially obliquely or perpendicularly to the sensor electrode sections. With respect to the surface areas of the heating circuits, the continuous base sections can in this case run on opposite end regions of a surface area which is monitored by the sensor electrodes, and the sensor electrode sections run to these base sections. In this case, the sensor electrode sections of one sensor electrode can reach from their base section to just in front of the base section of the other sensor electrode, particularly advantageously at a distance of from 1 mm to 10 mm. This distance can also be the same distance as between two adjacent sensor electrode sections, and particularly preferably is the same as the distance.

It is particularly advantageous when the width of the sensor electrode sections of in each case one sensor electrode remains the same in the region of a heating circuit. This preferably applies for precisely one heating circuit. Specifically, if all of the sensor electrode sections of the two sensor electrodes are of identical width, it is possible to identify an overtemperature with twice the fail-safety overall, but it is not possible to locate the overtemperature. However, if the sensor electrode sections of the two sensor electrodes have different widths in a region above at least one heating circuit, preferably with a difference of between 10% and 500%, an overtemperature which occurs can be associated with at least one heating circuit or a region above a heating circuit from amongst in each case several heating circuits by way of only two sensor electrodes. This can be performed by the leakage currents or fault currents at the two sensor electrodes being measured and related to one another. If the widths of the sensor electrode sections of the sensor electrodes differ considerably, for example the width of one is only 50% of the width of the other, on account of the higher surface-area overlapping of the sensor layer, the considerably higher leakage current or fault current can also be detected in the sensor electrode with the wider sensor electrode sections. If the widths of the sensor electrode sections lie below the abovementioned 1 cm, it can be assumed that a region of an overtemperature overlaps at least two adjacent sensor electrode sections and there in each case generates a fault current which is dependent on the area of overlap. If the fault current is considerably higher even at one sensor electrode than at the other, the overtemperature is present in that region of the heating device in which the sensor electrode has the wider sensor electrode sections.

The widths of the sensor electrode sections should advantageously differ by at least 50%, particularly advantageously by at least 100%. In this way, it is possible to draw a distinction in a reliable manner, even if the region with the overtemperature is not distributed equally over the two sensor electrodes or the sections of the sensor electrodes.

In a preferred refinement of the invention, the heating device can have three heating circuits.

The sensor electrode sections of the two sensor electrodes can have the same width in the region of one of the heating circuits. Therefore, if fault currents of approximately equal magnitude are established at two sensor electrodes, there is an overtemperature in this region or at the corresponding heating circuit. The sensor electrode sections of the two sensor electrodes can each have different, advantageously considerably different, widths in the region of the other two heating circuits. Therefore, even in the case of a considerably higher fault current being established at one sensor electrode than at the other, it is possible to draw a distinction between the presence of the overtemperature at one of these two heating circuits. Subdivision into even more than three regions or heating circuits is possible, but the ability to effectively and reliably draw a distinction in respect of the location of the overtemperature drops at the same time.

In order to effectively cover the heating circuits and primarily also to draw a distinction with sensor electrode sections of different widths, it is considered advantageous when each sensor electrode has at least two, preferably at least three, sensor electrode sections above each heating circuit. In this case, the widths of the respective sensor electrode sections are also not so large, and it is ensured that an overtemperature has an effect on at least two, advantageously at least three, sensor electrode sections owing to the increase in the fault currents.

Firstly, it is possible, as described above, to design the support to be flat, for example as a kind of plate, and to connect, in particular to thermally connect, the support to a container or channel which contains a fluid which is to be heated, in particular a liquid, or through which a fluid which is to be heated, in particular a liquid, flows. Examples of this include a base in a boiler and in a kettle.

Secondly, the support of the heating device is particularly advantageously in the form of a tube and therefore a container for liquid which is to be heated, which container, as it were, permanently contains the liquid. The liquid is evaporated by heating, for example for use in a steam cooker. Owing to the contact with the fluid, in particular a liquid, it is generally very readily possible to draw the heat from the heating elements of the heating circuits. Abovementioned overtemperatures can occur only when problems arise here or, for example, when limescale deposits build up when water is heated, the limescale deposits making it difficult to draw heat. The overtemperatures need to be identified and then operation at such an overtemperature has to be avoided since the heating device may otherwise be permanently damaged. In the case of a tubular support, the heating circuits are advantageously separated from one another along the longitudinal axis of the tube. In this case, the heating circuits should largely run around the support, advantageously in the manner of a sleeve, so that the surface area of the support which is as large as possible is covered by the heating circuits or the heating elements of the heating circuits for inputting power in as effective and as uniform a manner as possible. In this case, it is possible for a majority of the sensor electrode sections, in particular all of the sensor electrode sections, to run at a right angle in relation to the longitudinal axis of the tube. Particularly when water is intended to be heated using the heating device, the sensor electrode sections, and under certain circumstances the heating elements of the heating circuits too, should run parallel to a water surface. Therefore, expedient division of the heating circuits for adapted heating depending on the filling level in the tube is also possible.

In general, an overtemperature can be identified when a fault current at a sensor electrode increases by at least 10% to 50% or is more than 10 mA to 50 mA. If the fault current increases only at one sensor electrode, it is highly probable that there is a fault with the other sensor electrode. This should be indicated to a user and the heating power can then be reduced or even switched off entirely after a certain time during which the user does not take action, for example after one minute to five minutes.

In a refinement of the invention, it is possible for two protective circuits with in each case two resistors to be arranged in an electrical input circuit of an evaluation for the temperature sensor device. As a result, the evaluation or a corresponding control device can be protected.

In a further refinement of the invention, it is possible to carry out a short-circuit and/or cable-breakage test. In this case, a high-frequency signal can be fed to one of the two sensor electrodes. This is advantageously performed by means of capacitive decoupling by means of a capacitor or the like. The signal is then read back by means of the other of the two sensor electrodes using a control device and should correspond to the supplied signal in the case of a functional temperature sensor device. If a deviation in the signal shape and/or the signal level by, for example, at least 5% is identified, this is deemed to be a fault. A signal can then be output to a user and the operation of the heating device can be changed, in particular power is reduced or equally an entire heating circuit or even the entire heating device is switched off.

These and further features may be gathered from the claims, but also from the description and the drawings, with the individual features being capable of being implemented in each case by themselves or severally in the form of sub-combinations in an embodiment of the invention and in other fields and being capable of constituting advantageous and independently patentable versions for which protection is claimed here. The subdivision of the application into individual sections and intermediate headings does not restrict the general validity of the statements made under these.

### BRIEF DESCRIPTION OF THE SEVERAL VIEWS OF THE DRAWINGS

Exemplary embodiments of the invention are schematically illustrated in the drawings and will be explained in greater detail in the text which follows. In the drawings:

FIG. 1 shows a plan view of a heating device according to the invention having three heating circuits which are arranged next to one another and have heating elements and a temperature sensor device;

FIG. 2 shows a schematic view of the heating device from FIG. 1 with a detailed illustration of the temperature sensor device together with the driving arrangement of the temperature sensor device;

FIG. 3 shows a modification to the heating device from FIG. 2 with sensor electrode sections of different widths; and

FIG. 4 shows a further modification of a heating device according to FIG. 1 with a temperature sensor device of different design.

### DETAILED DESCRIPTION

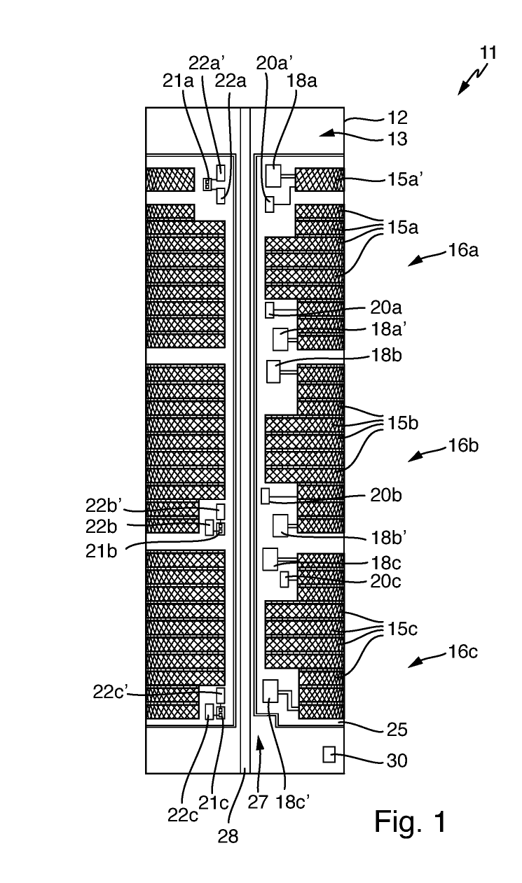

FIG. 1 shows an upright heating device 11 according to the invention which has a cylindrically round tubular container 12 which is composed of metal. Strip-like heating elements 15 which, as illustrated, run along approximately 75% to 90% of the outer circumference of the container 12 are provided on an outer face 13 of the container 12. Top heating elements 15a and the topmost heating element 15a′ form a top heating circuit 16a. Central heating elements 15b form a central heating circuit 16b, and bottom heating elements 15c form a bottom heating circuit 16c. In this case, the central heating elements 15b of the central heating circuit 16b and the bottom heating elements 15c of the bottom heating circuit 16c, and also the heating circuits 16b and 16c are identical to one another. The top heating circuit 16a is different in as much as the topmost heating element 15a′ runs at a distance of approximately 60% of a width of the normal heating elements 15a above the said normal heating elements, that is to say is at an increased distance, here.

Electrical contact is made with the heating circuits 16a to 16c by means of contact areas 18, specifically with the top heating circuit 16a by means of the contact areas 18a and 18a′. The central heating circuit 16b has the contact areas 18b and 18b′, and the bottom heating circuit 16c has the contact areas 18c and 18c′. Furthermore, additional contacts 20a′ and also 20a to 20c are also provided, specifically in each case one additional contact 20b and, respectively, 20c for the central heating circuit 16b and, respectively, the bottom heating circuit 16c. The top heating circuit 16a has an additional contact 20a with an arrangement similar to in the case of the central heating circuit 16b. A further additional contact 20a′ is also provided on the topmost heating element 15a′.

SMD temperature sensors 21a to 21c which form the discrete temperature sensors described in the introductory part are provided on the heating circuits 16a to 16c in the left-hand region. Two temperature sensor contact areas 22a and 22a′, 22b and 22b′ and also 22c and 22c′ are provided for each SMD temperature sensor 21a to 21c. The temperature sensor contact areas are fully electrically isolated from the heating circuits 16a to 16c. These discrete temperature sensors are highly suitable for determining the temperature of the water in the heating device 11 but not for locating a region with an overtemperature. The monitoring region of the discrete temperature sensors is far too small for this purpose.

A strip region 27 is provided in the centre of the container 12 along the longitudinal axis of the container, a weld seam 28 running in the strip region since the tubular container 12 is formed from a sheet metal and the edges which bear against one another are also welded to one another. A so-called outer-face contact 30 is fitted at the bottom of the container 12, for example for earthing purposes.

As has been explained in the introductory part, it is possible to produce a dielectric sensor layer on the heating elements 15 or the heating circuits in a homogeneous manner or from the same material or glass. However, as an alternative, it is also possible to use two differently conductive materials or glasses. These can even be fitted one above the other and/or one onto the other, wherein electrical contact has to be made with each one individually. The sensor layer forms, as it were, a flat, temperature-dependent electrical resistor which, at temperatures of up to approximately 80° C., wherein the temperature is adjustable, has a very high electrical resistance and therefore no current flows across the insulation layer. If the temperature also continues to rise only in a small range and reaches, for example, 100° C., the electrical resistance falls. At temperatures of 150° C. or 200° C. for example, the resistance in this small range can have fallen to such an extent that even though the electrical insulation properties are adequate for operating the heating circuits 16a to 16c without problems, a leakage current or fault current which can flow in the region of these temperatures can already be reliably detected.

High temperatures of this kind which are considerably above 100° C. can actually occur during operation of the heating device 11 or of an evaporator which is provided with the heating device and during evaporation of water only when firstly there is no more water as a result of the water boiling dry or secondly enough heat is no longer drawn owing to the formation of large limescale deposits at a point, so that overheating occurs. In the first case of their generally no longer being any more water in a region of this kind, a countercheck can be made with the state of the respective SMD temperature sensor 21a to 21c, primarily with the topmost temperature sensor 21a. If the countercheck also establishes a temperature of greater than 100° C., it is apparent that the filling level of the water has fallen. However, if the topmost SMD temperature sensor 21a still establishes a temperature of at most 100° C., there is a considerably higher temperature, which is established by the sensor electrodes together with the sensor layer 25, as an over temperature on account of the formation of excessively large limescale deposits on the inner face of the container 12. Depending on the magnitude of the flat region and on the level of the overtemperature, the corresponding heating circuit 16 can continue to be operated or else can be switched off. In each case, an operator can be provided with an indication as described in the introductory part in order to make the operator aware that limescale has to be removed from the heating device 11 or the evaporator.

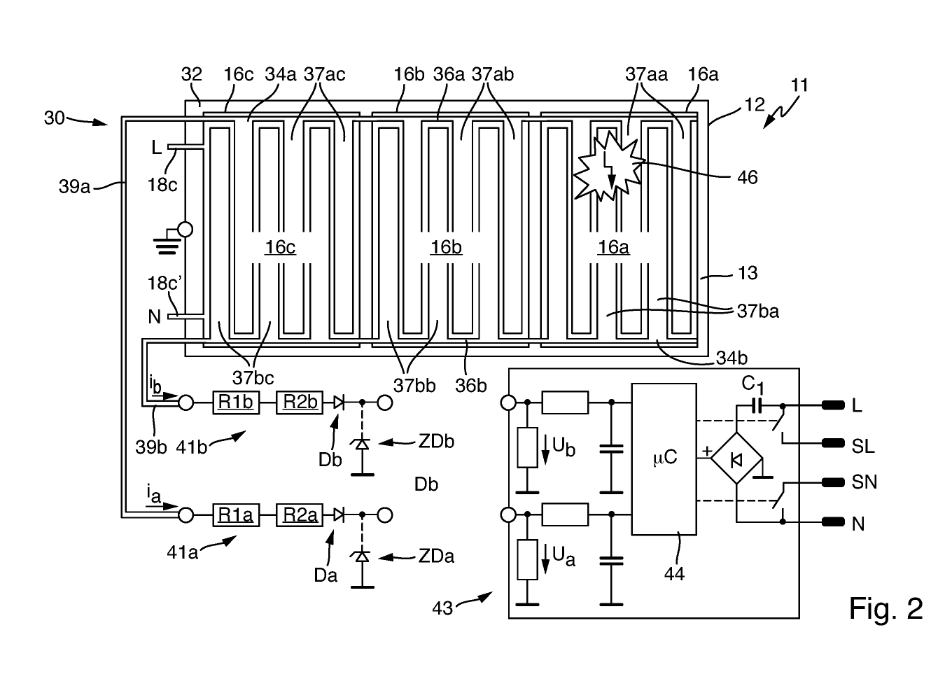

The highly schematic illustration of the heating device 11 in FIG. 2 is intended to be, as it were, a plan view of the support in the unwound state or if the support tube of the container 12 had been sectioned, that is to say lies flat. The illustration shows the three heating circuits 16a to 16c, the subdivision of the heating circuits into the individual heating elements not being illustrated here because this is not important for this aspect of the invention. The contact-connection of the driving arrangement of the heating circuits 16a to 16c is not illustrated here either. Only the contact areas 18c and 18c′ for the heating circuit 16c are schematically illustrated. This FIG. 2 also clearly shows that the three heating circuits 16a to 16c occupy regions which are separated from one another.

The temperature sensor device 30 is fitted onto the heating circuits 16a to 16c, specifically the abovementioned sensor layer 32 is initially fitted directly onto the heating circuits 16 over the entire surface area. This sensor layer 32 has at least the surface areas of the three heating circuits 16a to 16c; it is advantageously a full-surface-area or continuous sensor layer. The sensor layer can, for example, slightly overlap the surface areas of the heating circuits 16a to 16c and reach up to or just in front of the edge of the container 12 as the support. The sensor layer is fitted directly onto the heating circuits 16a to 16c and is composed of an abovementioned electrically insulating material, advantageously a glass material which is known. At room temperature and also at temperatures during operation of the heating device 11 for boiling or evaporating water, that is to say approximately 100° C., the material is electrically insulating with a virtually infinitely high electrical resistance. At the abovementioned overtemperatures starting from 150° C., advantageously between 200° C. and 300° C., the electrical resistance drops and an above-described fault current, also called leakage current, can pass through the sensor layer 32. Overtemperatures of this kind can occur when either there is no longer any water, which draws the produced heat, in the region on a heating element or on a heating circuit 16a to 16c. As an alternative, large limescale deposits can be produced on the inner face of the container 12, this likewise making it difficult to draw heat. The regions exhibiting such overtemperatures usually have a diameter of between 0.5 cm and 1.5 cm to at most 2 cm when the container 12 is approximately 20 cm to 30 cm long and has a diameter of approximately 6 cm to 10 cm. Very low local overtemperatures occur rather rarely since the cross-conduction of heat by the container 12 ensures sufficient heat distribution here. Considerably larger regions with overtemperatures likewise occur very rarely since then an overtemperature which should be identified and suppressed would already occur, specifically in the central region of the regions, considerably earlier.

Sensor electrodes 34a and 34b are once again fitted to the sensor layer 32, specifically in an electrode layer. In this case, the sensor electrodes 34a and 34b are both separated from one another at a distance of from 1 mm to 3 mm or at most 5 mm. The sensor electrodes 34a and 34b have, in principle, an identical configuration; the sensor electrode sections 37ac, 37ab and 37aa and also 37bc, 37bb and 37ba project toward one another in each case from a base section 36a and 36b which runs along the side. The width of the sensor electrode sections is approximately 5 mm to 1.2 cm. A comb-like structure of the sensor electrode sections 37 which engage one into the other is produced. It can be seen that these sensor electrode sections 37 cover more or less precisely only the surface areas of the heating circuits 16a to 16c; no overtemperature can occur in the intermediate spaces or next to the heating circuits anyway. In each case three sensor electrode sections 37 of the two sensor electrodes 34a and 34b of the temperature sensor device 30 for each heating circuit 16 are illustrated here. However, there could also be more sensor electrode sections 37. However, there should not be fewer than two. It can also be seen that all of the sensor electrode sections 37 have the same width and are at the same distance from one another.

Sensor supply lines 39a and 39b of the sensor electrodes 34a and 34b each lead to protective circuits 41a and 41b. Each of these protective circuits 41a and 41b has two resistors R1a and R2a and, respectively, R1b and R2b which are connected in series. A diode Da and Db and also a Zener diode ZDa and ZDb are connected downstream of the resistors in each case. The protective circuits 41a and 41b are connected to a possibly remote control apparatus 43 for evaluating the temperature sensor device 30. Therefore, it is possible for the protective circuits 41a and 41b to even be arranged on the container 12 as a support, but with the control apparatus being separate and being combined or integrated, for example, with a controller for an entire electrical appliance in which the heating device is installed.

The control apparatus 43 has series resistors and series capacitors connected upstream of a microcontroller 44. A further circuit arrangement which leads to outputs L, SL, SN and N is connected downstream of the microcontroller 44.

An overtemperature region 46 is shown in the heating circuit 16a. The centre of the overtemperature region lies above the central sensor electrode section 37ba but at the same time also overlaps the central sensor electrode section 37aa and also the sensor electrode section situated to the left of the sensor electrode section to a certain extent. Therefore, a fault current ib and ia can be registered at both sensor electrodes 34a and 34b. These fault currents ia and ib flow depending on the change in resistance of the sensor layer 32 in the overtemperature region 46. However, this includes not only the surface-area overlapping of the overtemperature region 46 over the sensor electrode sections 37, but also the respectively present temperature. If an established fault current exceeds a fault current threshold value which is defined, this is identified as an overtemperature and a fault situation is triggered. A signal can be output in the process; an above-described reduction in the heating power or even a switch-off may possibly also be performed. A fault current should not exceed 0.7 mA. A fault current threshold value can be selected to be, for example, 0.2 mA to 0.5 mA.

It is also clear from FIG. 2 that a situation of an overtemperature of this kind or an overtemperature region 46 could already be identified by one of the sensor electrodes 34a or 34b or the sensor electrode sections 37 of the sensor electrodes. Therefore, double fail-safety can be achieved; that is to say the temperature sensor device 30 also functions only with one of its temperature sensors. The two protective resistors in the protective circuits 41 serve to prevent damage or electrical destruction of the control apparatus 43 in the single fault case. The Zener diodes ZD limit the sensor voltage to a small signal level.

It can also be clearly seen on the basis of FIG. 2 that in each case two sensor electrodes of this kind with sensor electrodes sections which engage one in the other in a comb-like manner could be provided separately from one another for each heating circuit 16. However, in this case, both the outlay on connection and also the outlay for the protective circuits and on the control apparatus 43, at least in respect of its circuit arrangement, triple. Although this is possible, it involves considerable additional outlay. Nevertheless, it would of course be desirable to be able to limit a situation of an overtemperature region of this kind to the corresponding heating circuit 16, so that only the power of this heating circuit can be reduced or switched off. A power reduction can take place, for example, to such an extent that heating power is still generated and heat is introduced into the fluid to be heated but there is no longer a dangerous overtemperature.

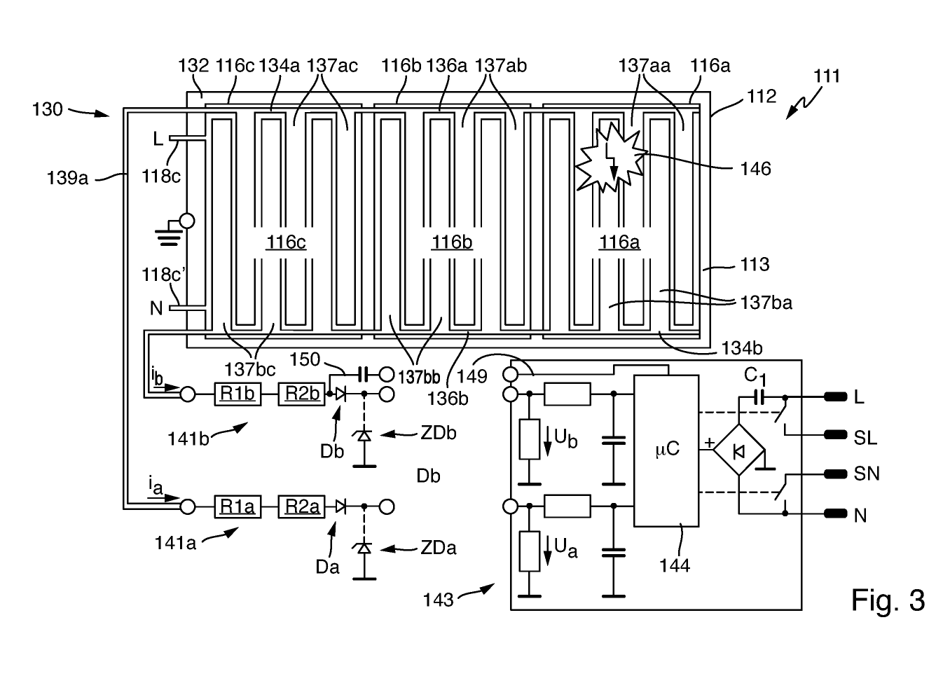

In order to enable this possible way of locating an overtemperature region for one of the heating circuits, the configuration of sensor electrodes 134a and 134b can be selected in accordance with the heating device 111 in FIG. 3. Both sensor electrodes 134a and 134b have sensor supply lines 139a and 139b and also base sections 136a and 136b in accordance with FIG. 2. However, the sensor electrode sections 137 protruding therefrom are of different design.

The three sensor electrode sections 137aa projecting downward from the base section 136a of the sensor electrode 34a are relatively thin and narrower than in FIG. 2 above the heating circuit 116a on the far right. However, the corresponding sensor electrode sections 137ba of the other sensor electrode 134b, which sensor electrode sections project upward from the bottom base section 136b, are wider than in FIG. 2; they are approximately twice as wide in the exemplary embodiment illustrated here. The respective sensor electrode sections 137ab and 137bb are of equal width above the central heating circuit 116b. The ratios are reversed over the left-hand side heating circuit 116c in comparison to above the right-hand side heating circuit 116a. The sensor electrode sections 137ac which extend downwards from the top are considerably wider than and, in particular, twice as wide as the sensor electrode sections 137bc which project upward from the bottom.

Owing to this configuration of the widths of the sensor electrode sections above in each case one of the heating circuits 116, the magnitudes of the fault currents ia and ib can be compared with one another and a conclusion can be drawn from this as to the region of which heating circuit 116 contains an overtemperature region 146. If, specifically, an overtemperature region 146 once again occurs above the right-hand side heating circuit 116a in accordance with FIG. 2, the larger width of the sensor electrode sections of the sensor electrode 134b mean that the surface area thereof affected by or overlapped by the overtemperature is much larger. Therefore, the fault current ib is considerably higher than the fault current ia, for example approximately twice as high. Owing to an accordingly considerably differently selected ratio, in particular 2:1 as is the case here or even more different, situations can also be clearly identified in which a centre of the overcurrent region lies directly above a relatively narrow sensor electrode section 137 but equally still overlaps considerably larger surface area regions of the sensor electrode sections of the other sensor electrode.

If the fault current ia is considerably higher than the fault current ib, there is an overtemperature region above the left-hand side heating circuit 116c. If the two fault currents are approximately equal, there is an overtemperature region above the central heating circuit 116b. As explained above, once the affected heating circuit has been identified, the power of the heating circuit can be reduced, for example by 20% to 50%. In most cases, the temperature in the overtemperature region is then higher than usual but no longer in a critical range. This situation of reaching a critical range could indeed be reliably and unambiguously identified. Therefore, it is not necessary to reduce or switch off the heating power of the entire heating device.

By splitting the ratios of the sensor electrode sections in relation to one another, even more than three surface area regions could also be monitored or distinguished between. However, this makes little sense in the case of a heating device illustrated here with three heating circuits. This would make sense only if there were more heating circuits or the heating circuits were subdivided once again. However, at the same time, care should also be taken that the reliability of identification of an overtemperature itself should have priority ahead of, as it were, additional functions such as location of the overtemperature, in all cases. In any case, location of an overtemperature illustrated here is readily possible by the fault currents is and ib being approximately proportional to the surface area ratios of the respective sensor electrodes.

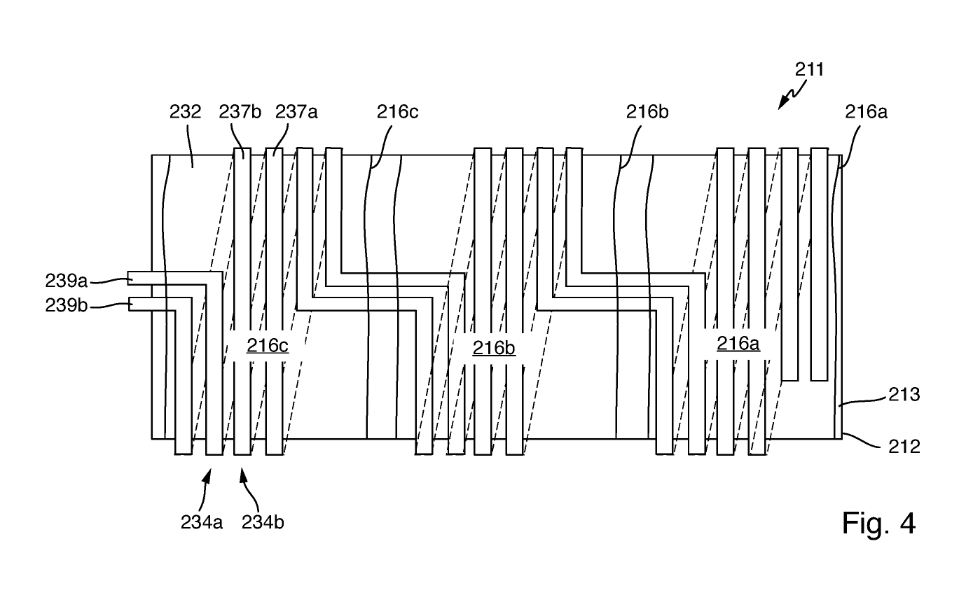

Furthermore, the way in which an abovementioned short-circuit or cable-breakage test can be carried out can also be clearly seen here. To this end, a correspondingly suitable high-frequency signal from the frequency connection 149 on the microcontroller 144 is fed to the sensor electrode 134b via a coupling-in arrangement 150 by means of the sensor supply line 139b. The coupling-in arrangement 150 has a capacitor for capacitive decoupling. The signal can then be read back via the other sensor electrode using the control apparatus 143, specifically via the normal connection of the control apparatus. There is a fault when no signal at all or a signal which is considerably changed, for example changed by at least 5% to 25%, returns in the process. This corresponds to a short-circuit or cable-breakage test which is customary per se. This can lead either to a reduction in power or to the switch-off of the heating device 111 or at least to a corresponding fault message being output to a user, advantageously optically and/or acoustically. FIG. 4 shows a further heating device 211, specifically not in the unwound state of the support tube as in FIGS. 2 and 3, but rather as a support tube according to FIG. 1 per se. While the sensor electrode sections are designed to engage one in the other in the form of a comb or in the form of fingers in FIGS. 2 and 3, sensor electrode sections 237a and 237b of sensor electrodes 234a and 234b run continuously next to one another, that is to say as it were in a bifilar fashion. Three heating circuits 216a, 216b and 216c are also fitted onto a container 212 or the outer face 213 of the container in separate regions here. The sensor electrode sections 237a and 237b run, as it were, in two double-turns above in each case one of the heating circuits 216. The free strip between two heating circuits is directly traversed by the sensor electrode sections, this not having to be perpendicular in practice however, as illustrated here, but rather it also being possible for this to take place in an oblique manner.

It can also be seen here that the sensor electrode sections 237a and 237b, similarly to those in FIGS. 2 and 3, overlap substantially the entire surface area of the heating circuits 216a to 216c, that is to say can monitor for overtemperatures. This can also be designed to be even better in respect of surface area. If an overtemperature region as in FIGS. 2 and 3 were to occur in the heating device 211, it would also be possible to detect the overtemperature region by the sensor electrode sections 237a and 237b.

In each case constant continuous width of the sensor electrode sections 237, which is identical in the two sensor electrodes 234a and 234b, illustrated here corresponds approximately to FIG. 2, that is to say location of an overtemperature region above one of the heating circuits is not possible. In a departure therefrom, the widths of the sensor electrode sections 237a and 237b which run above the heating circuits 216a to 216c could vary in accordance with FIG. 3 in the region of in each case one of the said heating circuits. That is to say, the sensor electrode sections 237b can be twice as wide as the sensor electrode sections 237a above the heating circuit 216a, they can be of identical width above the heating circuit 216b, and the sensor electrode sections 237a can be twice as wide as the sensor electrode sections 237b above the heating circuit 216c. As described with respect to FIG. 3, an overtemperature region can be located again by comparing the magnitudes of the fault currents which can be detected at the sensor electrodes 234a and 234b or the sensor supply lines 239a and 239b of the sensor electrodes.

A distance between the sensor electrode sections 237 should always be the same and furthermore relatively low, for example between 1 mm and 3 mm, in the heating device 211 of FIG. 4 too.

That which is claimed:

1. A heating device for heating fluids, comprising:
a flat support with a surface;
a plurality of heating elements being arranged distributed over said entire surface of said flat support;
said heating elements being divided into one or more heating circuits;
said one or more heating circuits are operable separately from one another;
a temperature sensor device with a sensor layer covering at least a surface area of said heating elements;
at least two sensor electrodes in an electrode layer being fitted onto said sensor layer;
said two sensor electrodes being electrically disconnected from one another and having finger-like or turn-like sensor electrode sections which run at a distance of less than 2 cm in relation to one another;
a width of in each case two said sensor electrode sections being arranged next to one another is less than 2 cm in each case; and
a control apparatus for evaluating said temperature sensor device.

2. The heating device according to claim 1, wherein said sensor electrode sections being arranged next to one another run parallel to one another.

3. The heating device according to claim 2, wherein said sensor electrode sections being arranged next to one another have an identical width.

4. The heating device according to claim 1, wherein:
said temperature sensor device is divided into at least two identification regions; and
each said identification region corresponds to one said heating circuit or is associated with one said heating circuit and is congruent with said heating circuit.

5. The heating device according to claim 1, wherein said sensor electrode sections run in a manner of elongate tracks in a bifilar fashion on said support.

6. The heating device according to claim 1, wherein said sensor electrode sections engage one into another in a comb-like manner or are interleaved one into another in regions overlapping with said heating circuits.

7. The heating device according to claim 6, wherein:
continuous base sections of said sensor electrodes are provided; and
said sensor electrode sections project in a manner of fingers from said continuous base sections.

8. The heating device according to claim 7, wherein said continuous base sections run on surface areas of said heating circuits with respect to opposite end regions and said sensor electrode sections of one said sensor electrode reach said base sections of said other sensor electrode.

9. The heating device according to claim 1, wherein a width of said sensor electrode sections of in each case one said sensor electrode remains the same in a region of one said heating circuit.

10. The heating device according to claim 9, wherein:
a ratio of said widths of said sensor electrode sections of said two sensor electrodes in relation to one another is different between 10% and 500% in a region above at least one said heating circuit;
said heating device comprises three said heating circuits and sensor electrode sections of said two sensor electrodes have an identical width in a region of one said heating circuit; and
said sensor electrode sections of said two sensor electrodes each have a different width in a region of said other two heating circuits.

11. The heating device according to claim 1, wherein each said sensor electrode comprises at least two said sensor electrode sections above each said heating circuit.

12. The heating device according to claim 1, wherein said support is in a form of a tube, and said heating circuits are arranged along a longitudinal axis of said tube separately from one another largely such that said heating circuits surround said support.

13. The heating device according to claim 12, wherein at least a majority of said sensor electrode sections run at a right angle in relation to said longitudinal axis of said tube.

14. A method for operating a heating device according to claim 1, wherein, in order to identify a region of said heating elements with an overtemperature at which a fault current between an electrical conductor and one of said sensor electrodes exceeds a prespecified threshold value, a fault current is measured at each of said two sensor electrodes and, if at least one fault current exceeds a fault current threshold value, an overtemperature is identified and a signal is then output to a user and/or operation of said heating device is changed.

15. The method according to claim 14, wherein two protective circuits with in each case two resistors for protecting an evaluation are arranged in an electrical input circuit of an evaluation for said temperature sensor device.

16. The method according to claim 14, wherein, in said heating device according to claim 10, a location of said overtemperature in a region of one of said heating circuits is identified by comparing a magnitude of said fault currents at said two sensor electrodes, wherein said magnitudes of said fault currents in relation to one another behave similarly to sizes of said surface areas of said sensor electrode sections of said sensor electrodes in a region of said heating circuit.

17. The method according to claim 14, wherein, when an overtemperature is identified, said operation is changed by power being at least reduced or switched off.

18. The method according to claim 17, wherein said operation is changed by said power of said heating circuit in a region where said overtemperature has been identified being at least reduced or switched off.

19. The method according to claim 14, wherein a short-circuit and cable-breakage test is carried out by a high-frequency signal being fed to one of said two sensor electrodes, wherein said signal is read back by means of another of said two sensor electrodes using a control device, wherein, when there is a deviation in signal shape and/or signal level by at least 5%, a fault is identified and a signal is output to a user and/or operation of said heating device is changed.

20. The method according to claim 19, wherein a short-circuit and cable-breakage test is carried out by a high-frequency signal being fed to one of said two sensor electrodes by means of capacitive decoupling by means of a capacitor or the like.

21. The method according to claim 14, wherein a change in operation of said heating device after an overtemperature is identified is at least a reduction in power or a switch-off of said heating circuit in a region in which said overtemperature has been identified.
